(19) United States
(12) Patent Application Publication
(10) Pub. No.: US 2009/0220682 A1
(43) Pub. Date: Sep. 3, 2009

(54) CATALYSTS FOR FUEL CELL APPLICATIONS USING ELECTROLESS DEPOSITION

(75) Inventors: John R. Monnier, Columbia, SC (US); John W. VanZee, Columbia, SC (US); Kevin D. Beard, Chester Springs, PA (US); Melanie T. Schaal, Columbia, SC (US)

Correspondence Address: DORITY & MANNING, P.A., POST OFFICE BOX 1449, GREENVILLE, SC, 29602-1449, US

(73) Assignee: University of South Carolina, Columbia, SC (US)

(21) Appl. No.: 12/063,716

(22) PCT Filed: Sep. 13, 2006
(86) PCT No.: PCT/US06/35767

§ 371 Date: Oct. 28, 2008

Related U.S. Application Data
(60) Provisional application No. 60/716,482, filed on Sep. 13, 2005.
(60) Provisional application No. 60/720,728, filed on Sep. 27, 2005.
(60) Provisional application No. 60/751,921, filed on Dec. 20, 2005.

(51) Int. Cl. B05D 5/12

(52) U.S. Cl. 427/113; 427/115

(57) ABSTRACT

The present disclosure is directed to a process for electroless deposition of metal atoms on an electrode. The process includes treating a carbon-containing support by contacting the carbon-containing support with a treatment, impregnating the carbon-containing support with a precursor metal component to form seed sites on the carbon-containing support, and depositing metal atoms on the seed sites through electroless deposition by contacting the carbon-containing support with a metal salt and a reducing agent.

### CROSS-REFERENCE TO RELATED APPLICATIONS

The present application is based on and claims priority to U.S. Provisional Application 60/716,482 having a filing date of Sep. 13, 2005, U.S. Provisional Application 60/720,728 having a filing date of Sep. 27, 2005, and U.S. Provisional Application 60/751,921 having a filing date of Dec. 20, 2005.

### BACKGROUND

Proton Exchange Membrane (PEM) fuel cells employ anode and cathode electrodes made of high weight loadings of catalyst supported on electrically-conductive supports. A common electrocatalyst used in PEM fuel cells is platinum (Pt) supported on electrically-conductive carbon.

With the growing commercialization of fuel cells and subsequent attempts to make the technology economically competitive, attention has been focused on lowering the cost of the Membrane Electrode Assembly (MEA) and, specifically, the catalysts used for electrochemical reactions. Because Pt is an expensive component of PEM fuel cells, it is important to minimize the particle sizes of the supported Pt particles (increase Pt dispersion) to increase the surface/volume ratio of the Pt particles.

Presently, fuel cells are also hampered in their performance by the sluggish reaction kinetics for oxygen reduction reaction (ORR) at the cathode. To overcome this limitation and reach desirable performance, high weight loadings of Pt on carbon catalysts are often utilized. The consequence of synthesizing high loadings of Pt on carbon by traditional methods (wet impregnation, incipient wetness, and co-impregnation) is the formation of larger Pt particle sizes. Such larger Pt particle sizes occur because the finite number of nucleation sites on the carbon support become saturated causing additional amounts of Pt tend to agglomerate onto already-taken sites, and the hydrophobicity of carbon results in discreetly distributed “droplets” of very high concentrations of Pt salts that are left on the carbon surface during solvent evaporation. The larger Pt particles that are subsequently formed have low dispersions (number of surface Pt atoms/total number of Pt atoms); thus, the efficiency of Pt utilization is lowered.

Current methods for increasing the catalyst's activity for the ORR include alloying it with another metal. However, the strategy of increasing electrocatalytic activity by increasing Pt particle size results in inefficient utilization of Pt atoms, since the larger particles have low surface/volume ratios of Pt atoms. Thus, improved catalysts should have high Pt dispersion, while maintaining high specific activity (activity per surface Pt atom) for dissociative adsorption of molecular oxygen.

Another hurdle for improving the cost-effectiveness of PEM fuel cells is the lifetime, or durability, of the MEA. Pt particles sinter during their operational lifetimes, with as much as 60% of the initial Pt surface area being lost by agglomeration to form larger Pt particles. Current methods used to lower sintering include alloying Pt with another metal, whereby the second metal interacts more strongly with the carbon support to “anchor” the Pt to the carbon surface. Such methods lower the rate of agglomeration and also provides the opportunity of perturbing the d-orbital structure of the Pt catalysts. Unfortunately, durability becomes a problem for alloys as well because some of the alloy metals tend to corrode during the course of fuel cell operation.

Thus, a need exists for improvements to increase the activity for the ORR, the durability of the catalyst, and even the dispersion of the catalyst metal before fuel cells can become economically competitive with other forms of energy conversion.

### SUMMARY OF THE INVENTION

Objects and advantages of the invention will be set forth in part in the following description, or may be obvious from the description, or may be learned through the practice of the invention.

The present disclosure is directed to a process for electroless deposition of metal atoms on an electrode. The process includes treating a carbon-containing support by contacting the carbon-containing support with a treatment, impregnating the carbon-containing support with a precursor metal component to form seed sites on the carbon-containing support, and depositing metal atoms on the seed sites through electroless deposition by contacting the carbon-containing support with a metal salt and a reducing agent.

In certain embodiments, the metal atoms may include Pt. The metal atoms may include a Group VIII and Group IB element. The metal salt may include a chloroplatinic salt. The metal salt may include a Group VII and Group IB metal salt. The reducing agent may include sodium hypophosphite, hydrazine, dimethylamine borane, alkylamine borane, sodium borohydride, and formaldehyde. The precursor metal component may include rhodium (Rh). The precursor metal component may include palladium (Pd). The precursor metal component may include a Group VIII and Group IB element. The precursor metal component may include a metal salt. The carbon-containing support may include carbon black, activated carbon, and carbon nanotubes. The treatment may include an alkaline treatment. The treatment may include an acidic treatment.

In another embodiment of the present disclosure, a process for electroless deposition of metal atoms on an electrode is disclosed. The process includes treating a carbon-containing support by contacting the carbon-containing support with an oxidizing treatment, impregnating the carbon-containing support with a precursor metal component to form seed sites on the carbon-containing support, depositing metal atoms on the seed sites through electroless deposition by contacting the carbon-containing support with a metal salt and a reducing agent, and depositing additional metal atoms at seed sites by contacting metal atoms with metal salt and a reducing agent.

Other features and aspects of the present disclosure are discussed in greater detail below.

### BRIEF DESCRIPTION OF THE DRAWINGS

A full and enabling disclosure of the present disclosure, including the best mode thereof to one of ordinary skill in the art, is set forth more particularly in the specification, including reference to the accompanying Figures in which:

Table I illustrates the effect of pH on PtCl₆²⁻ adsorption.

Table II illustrates decomposition of Platinum on blank carbon support.

Table III illustrates the effect of dimethyl-amine-borane (DMAB) concentrations on Platinum weight loading.

Table IV illustrates the effect of citrate concentration on electroless deposition.

Table V illustrates the effect of Rhodium weight loading on Platinum weight loading.

Table VI illustrates the effect of pH on electroless deposition.

Table VII illustrates rate constants.

Table VIII illustrates propylene hydrogenation data.

Table IX illustrates results from TEM analysis.

Table X illustrates results from TEM analysis.

Table XI illustrates evaluation of carbon support pretreatments.

Table XII illustrates results of H₂ chemisorption analysis for Pd precursor catalysts.

Table XIII illustrates results from TEM analysis.

Table XIV illustrates the comparison of actual and narrow particle size distribution for 8.0% Pt on 2.5% Pd/C.

Table XV illustrates results from hydrogen desorption peak analysis.

Table XVI illustrates the kinetic parameters from Tafel Region for ORR.

FIG. 1 illustrates the effect of dimethyl amine borane concentrations on Platinum weight loading.

FIG. 2 illustrates the effect of Rhodium weight loading on Platinum weight loading.

FIG. 3 illustrates the effect of pH on final Platinum weight loading.

FIG. 4 illustrates the effect of dimethyl amine borane concentration on rate of electroless deposition.

FIG. 5 illustrates the effect of Rhodium weight loading on rate of electroless deposition.

FIG. 6 illustrates the effect of citrate concentration on the rate of electroless deposition.

FIG. 7 illustrates the effect of pH on the rate of electroless deposition.

FIG. 8 illustrates the decomposition of dimethyl amine borane in solution.

FIG. 9 illustrates micrographs of Rhodium seeded support.

FIG. 10 illustrates micrographs of Pt—Rh/XC-72 catalysts.

FIG. 11 illustrates TEM images for Pt electrolessly deposited on Pd/C (Pd acetate in CH₂Cl₂ solvent).

FIG. 12 illustrates TEM images for Pt electrolessly deposited on Pd/C (tetraamine Pd nitrate in H₂O Solvent).

FIG. 13 illustrates TEM Images for Pt electrolessly deposited on Pd/C (tetraamine Pd nitrate in MeOH solvent) and 20% Pt/C standard (E-tek).

FIG. 14 illustrates Pt particle diameter distribution for Pd acetate precursor compared to standard E-tek 20% Pt/C and Pt on 0.5% Pd, 1.0% Pd, 2.5% Pd, and 5.0% Pd.

FIG. 15 illustrates Pt Particle diameter distribution for tetraamine Pd nitrate in H₂O precursor with 20% Pt/C standard and Pt on 0.5% Pd, 1.0% Pd, and 2.5% Pd.

FIG. 16 illustrates Pt particle diameter distribution for tetraamine Pd nitrate in MeOH precursor with 20% Pt/C standard and 0.5% Pd, 1.0% Pd, and 2.5% Pd.

FIG. 17 illustrates the actual and “narrow” particle size distribution curves for 8.0% Pt on 2.5% Pd/C.

FIG. 18 illustrates CV for 71 μg of 8.0% Pt on 2.5% Pd/C (ED) and 28 μg of 20% Pt/C commercial (standard) in 0.5M H₂SO₄ (a) and 0.1M HClO₄ (b).

FIG. 19 illustrates the Tafel region for 8.0% Pt on 2.5% Pd/C (ED catalyst)

### DETAILED DESCRIPTION

It is to be understood by one of ordinary skill in the art that the present discussion is a description of exemplary embodiments only, and is not intended as limiting the broader aspects of the present disclosure, which broader aspects are embodied in the exemplary construction.

The present disclosure is generally directed to a process for electroless deposition (ED). ED is a catalytic or autocatalytic process whereby a chemical reducing agent reduces a metallic salt onto specific sites of a catalytic surface which can either be an active substrate or an inert substrate seeded with a catalytically active metal.

In accordance with the present disclosure, ED provides a method for controlled deposition of Pt or other metal atoms on catalytic seed nuclei previously deposited on a carbon support. Because only low concentrations of metal salts are required for formation of seed nuclei, non-aqueous solvents can be used. During electroless deposition, the temperature and concentrations of metal salts, reducing agents, and complexing agents can be modified to give controlled rates of metal deposition on the seed nuclei. Thus, it becomes possible to chemically deposit Pt onto seed nuclei, resulting in the formation of very small metal particles having surface/volume ratios approaching unity. In this manner, the required loading of Pt necessary for satisfactory fuel cell performance can be dramatically lowered, resulting in significant savings on fuel cell costs.

In certain embodiments of the present disclosure, the electroless deposition technique disclosed herein involves the successive seedings of catalyst sites with an appropriate precursor and the subsequent electroless reduction of a noble metal catalyst on the seeded support. A novel aspect of certain embodiments of the present disclosure is the ability to deposit a metal on such seeded carbon. Such a method involves the determination of the proper temperature, composition of the solutions, and ratio of seed materials to noble metal catalyst for successful deposition. The deposition is autocatalytic and can be controlled with the proper selection of starting material and solution. The technique produces dispersions of noble metal catalysts which are greater than commercially available catalysts. Also, such dispersions allow for similar electrochemical activity at far lower loading of catalysts.

In some embodiments of the present disclosure, during electroless deposition, the carbon support can be impregnated with highly dispersed, metallic seed sites which act as catalysts for the activation of suitable reducing agents. Vulcan XC-72 carbon black (Cabot Corporation) is a carbon typical of those used for electrodes in PEM fuel cells. However, other carbon-containing supports can be utilized as would be known in the art including but not limited to activated carbon and carbon nanotubes.

Prior to impregnation of the seed metal component, the carbon is cleaned and dried. Many metals can be used as seed sites, or nuclei, and can typically be selected from any of the Group VIII or Group 1B elements including Rh or Pd. The precursor metal component can also be selected from a metal salt. Solvents such as dichloromethane, toluene, methanol, or deionized water often have adequate solubility for formation of metal nuclei capable of catalyzing subsequent metal deposition. After impregnation of the metal salts with the method described herein, the impregnated support is activated by reduction. The reduction may use gas phase materials or liquid phase agents, or in some embodiments, the reduction of the seed metal salt may occur when contacted with the electroless deposition solution, which also contains a suitable reducing agent. Temperature may be important in maintaining the reduced metal nuclei sites in small, discrete metal particles, or nuclei of only a few atoms. The subsequent deposition of metal atoms occurs only on the seed nuclei, and to a large measure, the concentration of seed nuclei controls the final concentration and size of the electrolessly deposited Pt, or other Group VIII or Group 1B metal, on the carbon support. Therefore, it is advantageous to have the highest possible concentration of seed material on the surface of the support.

The electroless deposition of the metal salt on the seeded carbon support is accomplished by immersion in a solution containing a suitable reducing agent and the metal salt. In accordance with the present disclosure, the reducible metal salt is stabilized from thermal reduction in the electroless developer solution. In some embodiments, the metal salt can include Group VIII and Group 1B metal salts. In certain embodiments, the metal salt may be a chloroplatinic salt.

The reducing agent is catalytically activated on the surface of the seed nuclei to form an active reducing species, such as a chemisorbed hydrogen atom or hydridic species. Reduction of the reducible metal salt dissolved in the electroless developer solution occurs at the site of the active hydrogen, or other reducing, species. Thus, deposition occurs only at the seed site, not randomly on the surface of the carbon support. The electrolessly deposited Pt, or other desired metal, may itself react further with the reducing agent to form more activated hydrogen species resulting in additional, yet controlled, growth of the metal particle. In some embodiments, the deposited metal atoms can include Group VIII and Group IB elements. This controlled sequence of growth gives better control of particle sizes and distribution of sizes than current, traditional methods of catalyst preparation.

The overall reaction for electroless deposition in accordance with the present disclosure is actually a combination of anodic and cathodic electrochemical partial reactions. Equation (1) is the overall combined reaction and equations (2) and (3) are anodic and cathodic partial reactions respectively.

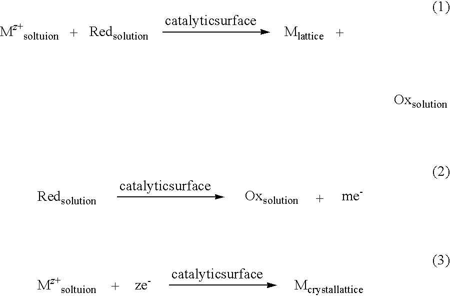

In the above equations, Ox is the oxidation product of the reducing agent Red. The catalytic surface could be a substrate or catalytic nuclei of metal M′ dispersed, or already deposited on, a non catalytic surface. From an electrochemical standpoint, the equilibrium potential of reaction (2) must be more negative than the equilibrium potential of reaction (3). The sum of the electrochemical behaviors of the two partial reactions equals the overall system equilibrium potential Eₘₚ during steady state. The site of reducing agent oxidation is the same for metal reduction; therefore, the anode and cathode are one and the same. This requires that the metal ion be reduced and deposited on the site that activates reaction.

There are several different reducing agents that can be used for electroless deposition in accordance with the present disclosure that include, but are not limited to, sodium hypophosphite, hydrazine, dimethyl-amine borane, diethyl-amine borane, sodium borohydride, and formaldehyde.

In certain embodiments, dimethyl-amine borane (DMAB) is utilized as a reducing agent. In an alkaline environment, DMAB reacts with hydroxide ions to form BH₃OH—, which is believed to be the active reducing agent. Furthermore, it is possible for each BH₃OH— molecule to provide up to six electrons for reduction.

The use of ED to fabricate Pt-containing electrocatalysts results in the formation of small particles that possess a core-shell geometry. This geometry offers the possibility of improving many aspects of fuel cell performance. In accordance with certain aspects of the present disclosure, the core can be some metal other than Pt. If the Pt shell thickness is thin enough, the core metal may be close enough to the surface to perturb the physical properties of the Pt surface layer (shorter Pt—Pt lattice parameters) and electronic properties of the surface Pt sites (Pt d-orbital vacancies).

Indeed, Pt can be used more efficiently because the core of the particles can be composed of less expensive, non-noble metals which allows the potential activity benefits of larger Pt particles while being more efficient in the use of Pt. The durability of the catalyst may be improved as well because of the “anchoring” effect of the core metal to the carbon support.

In certain embodiments, a method to achieve greater dispersion of a Pd precursor is achieved by creating an interaction between the support and the Pd compound. The extent of precursor-support interaction can result from factors such as polarity of the solvent, the pH of the impregnating solution, the cationic or anionic nature of the metal precursor, the ligating properties of the support with the Pd precursor, and the isoelectric point of the support and ultimately effect the interaction between support and precursor which ultimately effects the dispersion of the metal catalyst. For carbon supports such as carbon black, activated carbon, and carbon nanotubes, a method for creating an interaction between support and precursor is by pre-treatment with an oxidizing agent. In some embodiments, this oxidation is achieved by treating with nitric acid, hydrogen peroxide, or gas phase oxygen at high temperatures. Pre-treatment with an oxidizing agent can populate the carbon surface with different oxygen-based functional groups, the most common being carboxyl.

In some embodiments, the carbon-containing support is treated in a treatment bath. In some embodiments, the treatment bath can be acidic bath while in other embodiments, the treatment bath can be alkaline.

Oxygen-based functional groups can have many important effects on the carbon support such as providing nucleation sites for deposition of precursor compounds, anchorage sites for metal clusters to resist agglomeration and maintain activity, increasing the carbon's hydrophilicity, and altering the intrinsic point of zero charge of the support. The point of zero charge of the support can control the adsorptive mechanism of the solvated precursor onto the support.

Carboxyl groups on the carbon surface, when in aqueous solution, protonate and deprotonate with changes in pH. The pH where the protonation and deprotonation mechanisms are in dynamic equilibrium is known as the point of zero charge and is specific to each support. Point of zero charge can be shifted to a higher or lower pH based on the extent of surface oxidation and functionalization. Therefore, the rate and extent of adsorption can be controlled by modifying the support surface.

The following Examples are intended to be purely exemplary of the present disclosure. In the Examples given below, experimental data are presented which show some of the results that have been obtained from embodiments of the present disclosure for different materials, temperatures, and processes.

### EXAMPLES

### Example 1

### Introduction

Dimethyl amine borane (DMAB) is used as the reducing agent in this experiment. In an alkaline environment, DMAB reacts with hydroxide ions according to the following reaction:

(CH₃)₂NHBH₃+OH⁻=(CH₃)₂NH+BH₃OH⁻

It is believed the species that supplies electrons is BH₃OH⁻. Furthermore, it is theoretically possible for each BH₃OH⁻ molecule to provide six electrons for reduction; however, the molecule probably becomes less effective at reduction as it loses more electrons.

Catalyst Preparation

During the electroless deposition process, 2.0 g of carbon support is first seeded with Rhodium (Rh) particles by the wet impregnation of the appropriate amount of Rh₄(CO)₁₂ dissolved in 100 mL of dichloromethane. The excess dichloromethane is removed by rotary evaporation (50 mm pressure and 40° C.). The Rh-impregnated carbon support is reduced under flowing H₂ at 100° C. for 1-2 hours to reduce any residual, oxidized Rh species.

The electroless deposition bath consists of a reducible platinum salt, chloroplatinic acid, a chemical reducing agent, dimethyl amine borane, and a stabilizing agent, sodium citrate, to help maintain the platinum salt in the bath.

Chloroplatinic salt, at an initial concentration of 0.00014M, sodium citrate, and de-ionized water are combined. Sodium hydroxide is used to fix the initial pH and the temperature is fixed at 80° C. in a hot water bath. At this point, the DMAB and seeded carbon support are added simultaneously under vigorous agitation. The total deposition time used is 1 hour. However, if liquid timed samples are needed, they are removed via a syringe and then filtered through a 0.45 μm pore filter to remove solid particulates. Solid catalyst is collected after one hour of deposition using vacuum filtration and a 1 μm pore filter and then reduced under flowing H₂ at 100° C. for 1 hour.

Catalyst Characterization

Analyzed weight loadings (defined as g metal/g catalyst) of Pt and Rh are determined by atomic absorption using conventional analysis protocols. Propylene hydrogenation is performed in a gas phase open system reaction. A gas chromatograph paired with a thermal conductivity detector is used to analyze the feed and product streams. For Transmission Electron Microscopy (TEM), a Hitachi H-8000 electron microscopy is used. Images varying from 300,000× to 500,000× magnification are taken and analyzed for average particle size using a scale and calipers for a sufficient number of particles to obtain suitable particle size statistics. These measurements are compiled to estimate average particle diameter and dispersion. Chemisorption characterization is performed using a Quantachrome Instruments Gas Sorption System which uses H₂ as the selective adsorbate. This method of characterization provides dispersion and average particle size of the catalyst particles.

Results and Discussions—Final Platinum Weight Loading

The kinetic parameters that control the final amount of platinum deposited are time of deposition, deposition temperature, agitation rate, pH, Rh weight loading of the Rh/carbon substrate, and the concentrations of platinum salt, reducing agent, and stabilizing agent. Temperature is maintained at 80° C., the agitation is kept constant, and the initial concentration of the platinum salt is maintained at 0.00014M. Thus, the direct influence of these three parameters on the final weight loading of platinum is not analyzed. The remaining variables are examined in detail.

Deposition is just one mechanism for Pt salts to become attached to the carbon substrate; the others are adsorption and decomposition. Both adsorption and decomposition are undesirable mechanisms and attempts are made to kinetically limit them. The solution pH has the greatest affect on adsorption with basic conditions limiting the mechanism to an acceptable level. This is because at basic conditions the acidic (electrically positive) sites on the carbon support are removed which eliminates the attractive forces felt between the carbon and the electrically negative chloroplatinic ion. Table I illustrates a series of experiments that elucidate this trend.

All of the experiments in Table I use a carbon support that has not yet been seeded with Rh. Also, the molar ratio of Pt:DMAB is 1:0 meaning there is no reducing agent in the electroless deposition bath and any Pt found on the support after the deposition must be the result of adsorption. The theoretical maximum platinum loading is the platinum weight loading if all Pt in solution were deposited on the support. In the second experiment, the carbon support was placed in a boiling caustic solution of pH 14 prior to being added to the ED bath. Results show a slight memory effect on the carbon; ultimately however, raising the pH of the ED bath to basic has the most profound effect in limiting adsorption.

Decomposition involves the thermal reduction of Pt salts in solution, but not at the catalytically active sites on the substrate. Once reduced, the metallic platinum precipitates from solution and is captured by the carbon support during agitation. Stabilizing agents are intended to limit the mechanism of decomposition by forming a protective screen around the chloroplatinic ions through ligand attractions; however, results show that, as in the case of adsorption, pH has the greatest limiting influence on decomposition. Table II illustrates the results of experiments designed to limit decomposition.

The series of experiments in Table II differ from those presented in Table I because the Pt:DMAB molar ratio is 1:5, making it possible to have both decomposition and deposition. Deposition is removed by using a blank carbon that lacks any catalytic activity. As seen in Table II, the final weight loading of platinum approaches zero at higher pH. Thus, both decomposition and adsorption are hindered at higher pH.

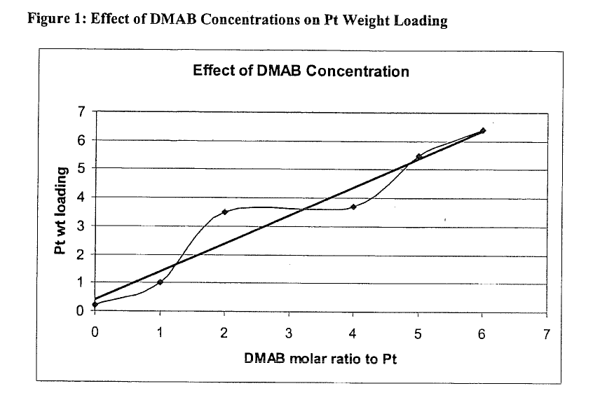

To evaluate the effect of the DMAB concentration on final Pt weight loading, the DMAB molar ratio versus platinum is varied from 1:0 to 1:6. In all the following experiments, the Rhodium weight loading is 0.5% and the initial pH is set at 11. As in previous experiments, the maximum theoretical weight loading of Pt is 6.7%. Table III and FIG. 1 present the results of these experiments.

From this data, it is clear that there is a linear relationship between initial concentration of DMAB and the final Pt weight loading. The linear relationship between initial concentration of reducing agent and the final amount of metal reduced makes intuitive sense and has been corroborated by data in the literature.

A series of tests using 0.5% Rh seeded carbon, an initial pH of 11, and a molar ratio of Pt:DMAB of 1:5 and varying the concentration of citrate relative to platinum, shows that the citrate does indeed have an effect on final concentration; however, this relationship is not a linear one as would be expected. At a high molar ratio of Pt:Citrate of 1:8, the final Pt weight loading is seen to go down as it should given a higher concentration of stabilizing agent which makes attack of the chloroplatinic salt by the reducing agent more difficult. However, the final Pt weight loading also goes down for a Pt:Citrate molar ratio of 1:2. The explanation for this trend is that some thermal decomposition, or reduction, is occurring in the ED solution and not on the surface of the Rh seeded surface; this Pt metal is being washed off the carbon during the rinsing of the solid after the completion of the ED process. Thus, while more oxidized platinum is being reduced, less is finding its way onto the carbon support. This data is shown in Table IV and indicates the need to have sufficient stabilizing agent in the ED solution.

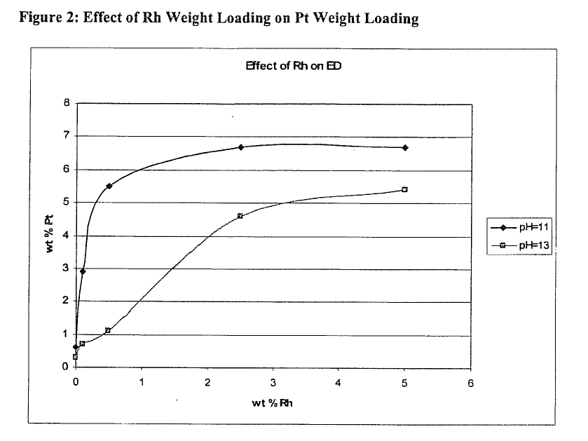

To understand the kinetic role of Rh on ED, several experiments are performed with varying Rh loadings. For these series of experiments, supports with Rh weight loadings of 0.0, 0.1, 0.5, 2.5, and 5.0% are synthesized. The initial pH of all experiments is set at 11 and then again at 13 for the second series. The Pt:DMAB:Citrate molar ratio is maintained at 1:5:5. The results of these experiments are shown in Table V and FIG. 2.

The data from these experiments show that final Pt weight loading increases as Rh weight loading increases up to around 2.5% Rh weight loading. After this point, all platinum in solution has been reduced on the support. This trend also suggests that given enough time, a support with less than 2.5% Rh weight loading would be able to reduce all platinum ions in solution. In FIG. 2, the difference in Pt deposition as a function of pH is exactly as expected where the higher pH appears to have shifted a very similarly shaped curve downwards reflecting the greater degree of stability felt at higher pH.

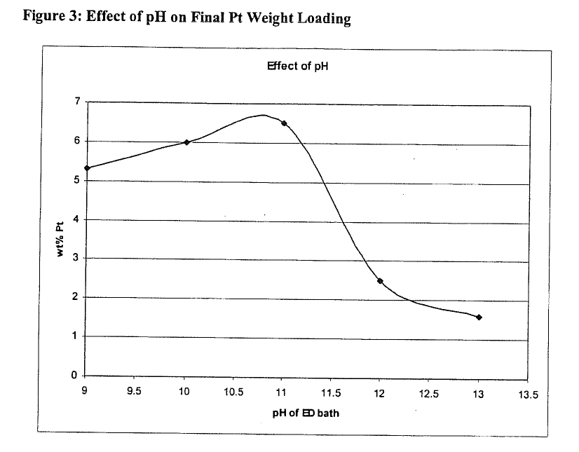

In testing the kinetic influence of initial pH on platinum deposition, all experiments have a Rh weight loading of 0.5% and a Pt:DMAB:Citrate molar ratio of 1:5:5. The pH is varied between 9.5 and 13 for these experiments. Only the initial pH is examined because initial tests showed that the pH varied very little over the course of the ED. The results of these experiments are presented in Table VI and FIG. 3.

Perhaps the most striking feature of FIG. 3 is its resemblance to the data in Table IV and this illustrates the similar roles played by pH and citrate in stabilizing the chloroplatinic ions in solution. The “hump” observed in FIG. 3 is the result of decomposition of the ED solution at lower initial pH and greater stability of the ED solution at higher pH. This is essentially the same argument applied to Table IV to show the decrease in final Pt weight loading despite creating an environment more conducive to reduction by having less stabilizing agent.

Results and Discussion—Rates of Electroless Deposition

The same kinetic parameters that affect the final platinum weight loading also affect the rates of electroless deposition. Therefore, the following rate of deposition equation can be written that takes into account these factors:

$$\frac{d {C}_{Pt}}{d t} = {k}_{o} {C}_{Pt}^{α} {C}_{DMAB}^{β} {C}_{citrate}^{χ} {C}_{{OH}^{-}}^{δ} {C}_{Rh}^{ɛ}$$

where C_{Rh} is the surface concentration of Rh, a function of the weight loading and dispersion of the Rh, k₀ is the initial rate constant and is a function of temperature and agitation in the bath, and

$$\frac{d {C}_{Pt}}{d t}$$

is the rate of ED.

Of the variables that influence the rate of ED, the concentration of DMAB, citrate, and OH⁻ and the surface concentration of Rh are examined. Liquid samples were withdrawn from the ED bath at timed intervals and it is assumed that any decrease in concentration of chloroplatinic salts in solution is the result of their being deposited electrolessly on the carbon support. Therefore, accurate readings can only be gathered at higher pH levels where there is little decomposition and adsorption and the above assumption holds.

The region of interest when looking at kinetic parameters is the first ten minutes of deposition because it is in these initial rates that the assumption of first order dependency on Pt is held. Past ten minutes it is seen that the reducing agent concentration falls precipitously and a first order dependence on the concentration of chloroplatinic ions alone is not valid. When examining the following figures, it is important to realize that initial rate of deposition is the slope of the curve of concentration Pt in solution versus time. The steeper the initial slope, the greater the initial rate of deposition.

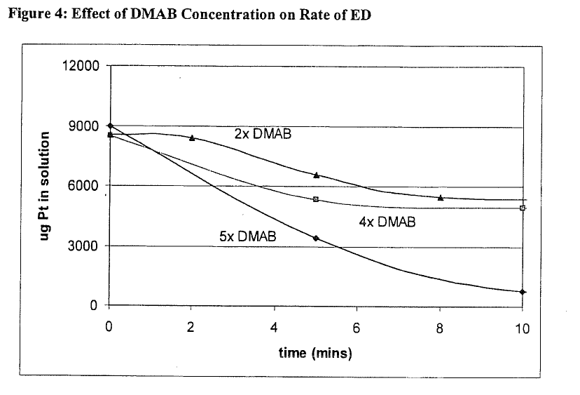

The first parameter tested is concentration of DMAB in solution. For these experiments, the pH is set at 11 and the seeded support is 0.5% Rh weight loading. As in all previous runs, the maximum theoretical Pt weight loading is 6.7%. FIG. 4 illustrates the results of these experiments.

The results of these experiments mirror and expound on the results presented above in Table III and FIG. 1. There is a clear pattern that the greater the molar DMAB ratio versus platinum, the steeper the initial slope, which follows the rate of deposition equation above.

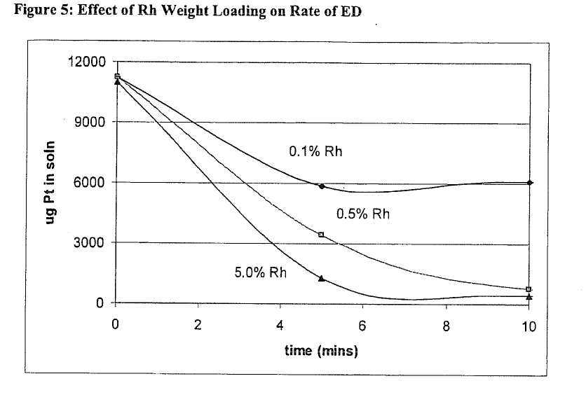

The second variable examined is Rh weight loading on the carbon substrate, which in turn affects the surface concentration of Rh particles. It is assumed that the dispersion of Rh on the surface is the same for the different weight loadings; an assumption that is later confirmed. For these experiments, the initial pH was set at 11 and a molar ratio of Pt:DMAB:Citrate was set at 1:5:5. The findings for these experiments are summarized in FIG. 5.

The results concur with statements made regarding FIG. 2 in that the 0.5% and 5.0% Rh loaded support will both accept nearly all platinum ions in solution. Also, there is a clear trend that the initial slope becomes steeper with higher Rh surface concentration. What is surprising in this figure is the curve for a Rh weight loading support of 0.1%. This finding seems to contradict the theory that given time, even a lightly seeded support, such as 0.1% will eventually have all platinum ions in solution deposited on it. It was later discovered from a different experiment that additional time will not increase the amount of deposition. The cause of the plateauing effect is the result of DMAB decomposition in solution.

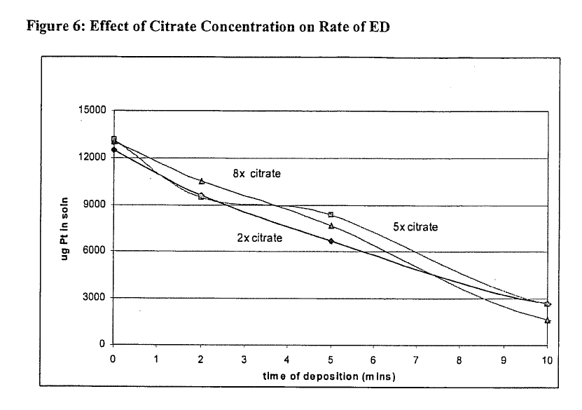

The influence of citrate concentration on the rate of deposition was a test with three experiments with the Rh loading fixed at 0.5%, the pH fixed at 1, and the molar ratio of DMAB fixed at 5 relative to platinum. The molar ratio of citrate relative to platinum was varied to 2, 5, and 8. The results of these experiments are shown in FIG. 6. These results suggest that there is very little dependence of concentration of citrate on rate of ED. Evaluating this data to find an initial rate constant supports this conclusion with all the runs possessing fairly close initial rate constant; however, the run with a ratio of 8 citrate per platinum molecules does yield a slightly higher initial rate constant. These rate constants are found in Table VII. Ultimately, this all probably means that χ from equation (5) is very small and close to zero.

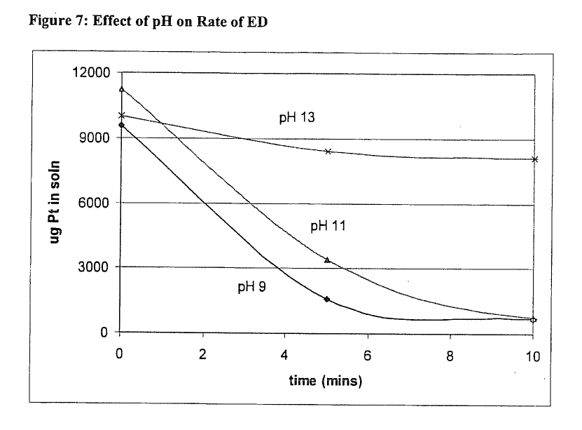

FIG. 7 illustrates an interesting trend that seems to contradict the prediction made by (5). While there is a great difference in initial slopes between the pH 13 and pH 11 runs, there is practically no difference observed between the slopes for pH 11 and pH 9.

This suggests that the actual concentration of OH⁻ ions does not directly affect the rate of ED; rather, the pH affects the ability of the reducing agent to reduce the metallic ions in solution. If the ED bath is too basic, the reducing agent is not effective; however, baths of moderate acidity to moderate alkalinity (such as pH 9 to pH 11) are effective mediums for DMAB to act as a reducing agent. Based on these conclusions, the rate of ED should be rewritten as follows:

$$\frac{d {C}_{Pt}}{d t} = {k}_{o} {C}_{Pt}^{α} {C}_{DMAB}^{β} {C}_{citrate}^{χ} {C}_{Rh}^{δ}$$

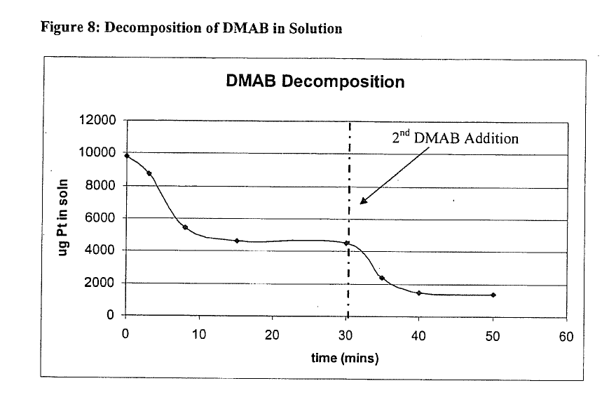

Next, the plateau seen to form after ˜15 minutes for every experiment must be addressed. This plateau is the result of the reducing agent decomposing to form H₂ gas in addition to being consumed during reduction. This behavior is shown in FIG. 8 where the Pt:DMAB:Citrate ratio is 1:5:5, the initial pH is 11, and the Rh support used is 0.5%. The experiment starts off as all others; however, at 31 minutes, a second batch of DMAB is added. Notice that after the initial addition of DMAB, the amount of Pt in solution plateaus after ˜15 minutes. Then notice how it begins to fall once again as soon as the 2^{nd} batch of reducing agent is added to the solution. This proves that the cause of the plateau is the result of a lack of reducing agent.

To find the actual initial rate constant, the equation above is used assuming that C_{DMAB}, C_{citrate}, and C_{Rh} are constant (which is a reasonable assumption in the first ten minutes). The equation above can then be integrated with respect to time to result in a linear equation where the slope of the equation is the rate constant. These rate constants are presented in Table VII and have units of

$$\frac{mol}{min * {g}_{cat}} .$$

Results and Discussion—Propylene Hydrogenation Characterization

A propylene hydrogenation reaction is performed on the Rh seeded carbon supports. The propylene hydrogenation reaction is chosen because it is widely considered to be a “structure-independent” reaction and the shape and form of the catalyst is unimportant in determining reaction rate. Having removed shape as a variable of reaction rate, propylene-hydrogenation can be used as a probe to find the number of active surface sites (Rh sites) on the catalyst support through comparison of reactor performance to standard catalysts with a known number of active sites.

A turnover frequency for Rh hydrogenating propylene is found using an Engelhard 2% Rh on Silica (batch CD04174) for which surface area data is found using chemisorption by the manufacturer. The number of surface sites on the catalyst is back-calculated using the rate of reaction and the turnover frequency found using the standard catalyst. Knowing the overall Rh weight loading from flame AA, the dispersion (surface Rh atoms/total Rh atoms) can also be calculated. The rate of reaction is found using a thermal conductivity detector. Table VIII presents the data found for supports seeded with 0.5%, 2.5%, and 5.0% Rh in addition to the 2% Rh on Silica standard catalyst from Engelhard.

From Table VIII, one of the most important observations is that the reaction rate for 2.5% Rh is almost five times greater than the rate for 0.5% Rh. With a reaction rate five times higher for the support with a weight loading that is also five times greater suggests that the size of the particles must be similar. This is not true in the case of the 5.0% Rh support where the reaction rate is about 7 times higher than the 0.5% Rh support, despite having ten times more Rh. This indicates that despite having ten times more Rh on the catalyst, less than that amount of additional Rh is found on the surface of the Rh particles which implies larger Rh particles.

Based on this information, it is believed that the most economical use of the Rh anchor lies around 2.5% because at this point, the Rh particles are no larger than that of the 0.5% Rh support. This is economical not only for the Rh, but also the Pt. It is known that electrolessly depositing the Pt on the support requires catalytic activation; thus, Pt will only be deposited on the seeded Rh. This in turn dictates a higher Rh loading; however, too great a loading will lead to larger Rh particles and any gain in increased loading will be offset by lower dispersion. The ideal Rh loading for Pt deposition is thus a compromise.

Results and Discussion—TEM Characterization Results

Transmission Electron Microscopy (TEM) is used to characterize the surface of the prepared catalysts and the Rh seeded carbon supports.

Unfortunately, there are several problems with this technique. First, at this magnification, it is difficult to get a well focused image which blurs the particle making an accurate measurement of their size difficult. It is very possible that most of the particles measured are actually smaller than recorded because the blurring would make them appear larger. Second, it is also possible that only the largest of particles are ever noticed and recorded and that a significant fraction remains below the threshold of detection, even at 500,000 times magnification. Third, this technique assumes that the images taken and subsequently analyzed are indicative of the average sizes and dispersions. Despite the foregoing, this is still a useful characterization tool that can be used to corroborate data found using other techniques.

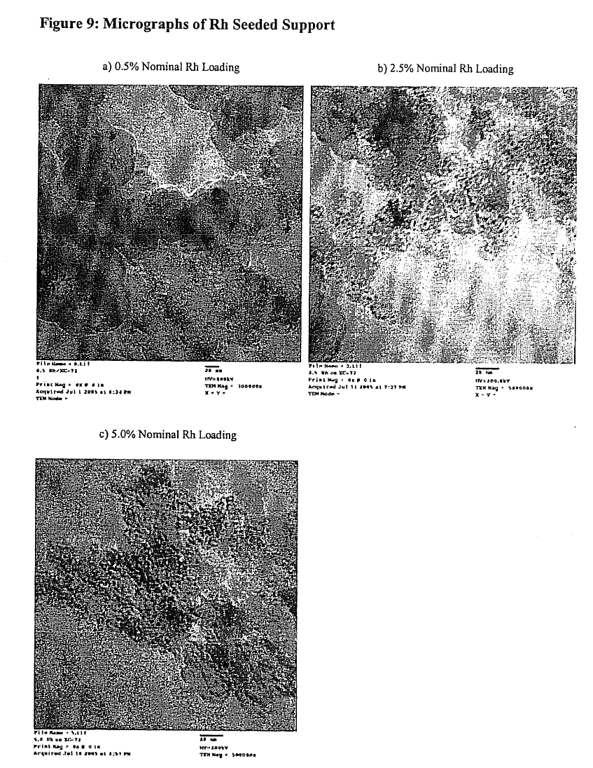

TEM micrographs are made for both the Rh seeded carbon supports and the final Pt—Rh catalysts. FIG. 9a, b, and c show the micrographs of the 0.5%, 2.5%, and 5.0% nominal weight loaded Rh supports.

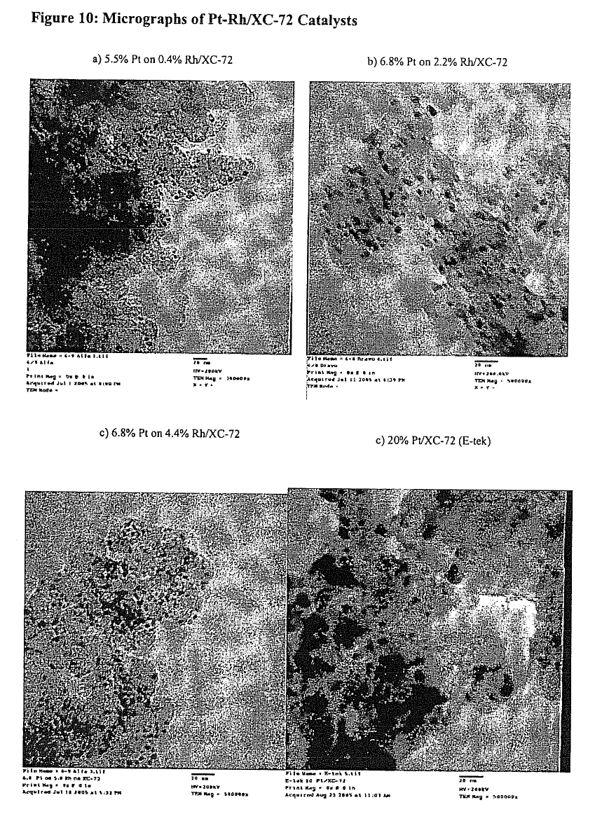

As shown in 9a, there is a very low site density for Rh particles for the 0.5% Rh loaded sample. Also, the particles seem rather large compared to those seen in 9b and 9c. Many attempts were made to find an area with a greater particle population than is shown in FIG. 9a, but no such area was found. The images seen in FIGS. 9b and 9c are fairly indicative of the average site concentration observed. Micrographs for the Pt—Rh bimetallic catalyst are shown in FIG. 10a, b, c. All three of these catalysts were prepared at a Pt:DMAB:Citrate ratio of 1:5:5 and a pH of 11. These conditions are considered the most favorable for a maximum amount of deposition. FIG. 10d illustrates a 20% Pt/XC-72 commercial catalyst from E-tek and is included for comparison purposes. While many of the particles in the commercial catalyst are of the same size as seen in 10c, there is also a large variance in size with some particles being as large as about 12 nm.

From these micrographs, one can see that the higher the Rh loading, the smaller the final Pt particles are. This confirms what is predicted during propylene hydrogenation. If the initial amount of platinum stays the same, then given more sites on which to deposit, those deposits will result in smaller Pt particles. However, such an observation is quite simple and a further analysis of measuring particle diameters is undertaken. The final results from this analysis are presented in Table IX and Table X. This analysis includes several micrographs for each catalyst, not just the ones presented above, to ensure as accurate an analysis as is reasonably feasible.

In measuring the size of the particles in the micrograph, roughly 200 were counted for each catalyst. Using the known Pt loading from AA and the average particle diameter, the dispersion and concentration of Pt—Rh particles can be determined.

Conclusions

Thus, it has been shown that Pt salts have been reduced and deposited on a catalytically active Rh seed on XC-72. A methodology for synthesizing both the Rh seeded supports and electrolessly depositing Pt on the seed metal has been determined. An evaluation of the effects on final Pt weight loading and rate of deposition of the various kinetic parameters has also been performed. Lastly, the resulting supports and bi-metallic catalysts have been characterized using a propylene-hydrogenation reaction and transmission electron microscopy.

### Example 2

This project focuses on the process of seeding the carbon support (Vulcan XC-72 carbon black, Cabot Corporation) with a precursor using a technique that is more effective in dispersing the seed metal, addressing the foregoing description regarding the influence that seed nuclei concentration has on final particle size and concentration. The carbon black is cleaned and dried in nitric acid, as before. However, before seeding the carbon with the precursor, the carbon is treated in a highly alkaline bath to create an electrical interaction between precursor and support that results in a more highly dispersed precursor. The Group VIII precursor, in this case palladium in the form of palladium acetate, is then deposited on the carbon surface using a traditional wet impregnation technique. The precursor sites on the surface of the support are then reduced using liquid phase reducing agents. The procedure to electrolessly deposit platinum on these seeded supports is described in the previous example.

Many benefits are demonstrated with this method. It has been shown through different characterization techniques that the precursor has been dispersed on the carbon surface to a greater degree than previously. This has resulted in smaller final platinum particles and a higher dispersion and efficiency of platinum use.

In addition, the shell-core geometry for the catalyst particles that arises naturally from this method of synthesis offers two important advantages. First, the bi-metallic composition confers an increased level of activity for a variety of reasons. Second, and perhaps more importantly, this special geometry may increase the longevity of the catalyst due to an anchoring effect between the precursor metal and the support surface.

### Example 3

### Catalyst Synthesis

Vulcan XC-72 (Cabot Corporation) was impregnated with different Pd compounds to activate the subsequent electroless deposition of platinum. The XC-72 carbon was initially pretreated at 90° C. in an aqueous bath at pH 14 to convert the surface carboxylic acid groups present on the carbon to the corresponding carboxylate groups, to introduce an electrostatic attraction between the RCOO⁻ groups and the positively charged Pd²⁺ cations in solution during wet impregnation. Three different Pd precursors were tested: an organometallic compound (bis-allyl palladium chloride), a covalent salt (palladium acetate), and an ionic salt (tetraamine palladium nitrate), all supplied by Strem Chemicals. Dichloromethane (Acros Organics) was used as the solvent for the bis-allyl palladium chloride and the palladium acetate, while methanol (MeOH) (JT Baker) and de-ionized water were used as solvents for the tetraamine palladium nitrate. Following wet impregnation of the Pd precursor compounds, excess solvent was removed by rotary evaporation. Reduction of the Pd precursor compound to metallic palladium was accomplished by exposure of the impregnated carbon support to an aqueous solution of sodium borohydride (molar ratio of BH₄⁻/Pd=10) at room temperature. Platinum was then deposited on the palladium by electroless deposition using the method described in the previous example. In all experiments the maximum theoretical platinum loading was maintained at 8.4% by weight. The conditions for all electroless deposition baths was a 1:5:5 mole ratio between Pt:DMAB:Citrate at an initial pH of 11. Deposition times were kept constant at 30 minutes.

Characterization

Analyzed weight loadings (defined as g metal/g catalyst) of Pt and Pd were determined by a Perkin-Elmer Atomic Absorption Spectrometer 3300 using conventional analysis protocols. Palladium dispersions and average palladium particle diameters were established by a Quantachrome Instruments Gas Sorption System using H₂ or CO as the selective adsorbate. Hydrogen was used as the adsorbate for all samples with certain samples retested using CO to validate the H₂ results. Transmission electron microscopy (TEM) (Hitachi Model H-8000) was used to determine the Pt particle size distributions. The micrograph images were measured using a scale and caliper to calculate average Pt particle sizes and Pt dispersions. In all cases, a statistically-relevant number of Pt particles were measured to ensure valid size distributions. For comparison, a 20 wt % Pt/XC-72 commercial catalyst from E-tek was also analyzed by TEM.

Electrochemical characterization was conducted by a glassy-carbon Rotating Disk Electrode (RDE) and Rotating Ring-Disk Electrode (RRDE) studies using a Pine Instruments AFASR rotator and a Princeton Applied Research PAR-273A and PAR-283 Potentiostat. Catalyst films were prepared from appropriate aliquots of a sonicated 2.8 mg_{cat}/mL catalyst suspension to yield a Pt loading of 5.6 μg per film. Once deposited, the catalyst film was fixed with a 5 μL aliquot of a 20:1 isopropyl alcohol:Nafion® solution. Electroactive surface area measurements were conducted in a de-aerated 0.1M HClO₄ or 0.5M H₂SO₄ electrolyte at 5, 10, and 25 mV/sec scan rates while the ORR kinetic analysis was performed in oxygen saturated 0.1M HClO₄ or a 0.5M H₂SO₄ electrolyte with a scan rate of 1 mV/sec and rotation rates between 250 and 2400 rpm.

Results and Discussion

Effect of Carbon Pretreatment

Three different types of Pd precursor compounds were examined to determine whether smaller Pd particles could be prepared relative to the Rh₄CO₁₂ precursor in Example 1. To further enhance precursor dispersion, a functionalization step prior to wet impregnation was added to the synthesis procedure. After cleaning the carbon in nitric acid to remove ash residues, the active surface sites on the carbon most likely exist as carboxylic acid groups. Following treatment in the pH 14 bath, these acids sites are converted to the negatively charged carboxylate species (RCOO⁻). This results in an electrostatic attraction between the positively charged Pd²⁺ cations and the carboxylate groups on the carbon support during wet impregnation of the Pd²⁺ compound, which can potentially limit agglomeration of Pd atoms during reduction in BH₄⁻ to form smaller Pd precursor, or seed, particles. The effects of base pretreatment are shown in Table XI. Table XI compares pH 14 pretreatment with no pre-treatment at all. Average Pd particle diameter and dispersion were determined by H₂ chemisorption.

Clearly, the pH-14 pre-treatment resulted in a decrease in Pd particle size for both, bis-allyl palladium chloride and palladium acetate; however, the effect is more profound with the Pd acetate. This is not surprising because the bis-allyl palladium chloride dimer is an organometallic compound, not a salt, and should not dissociate into anion and cation, each with an electrical charge while in solution like the Pd acetate. By dissociating, the Pd precursor compound can take advantage of the electrical attraction with the support. Based on these results, catalysts discussed below followed a standard synthesis procedure: i) cleaning of the carbon in a nitric acid solution for 1 hour at 50° C., ii) washing the carbon support with DI-H₂O and drying at 100° C. under vacuum, iii) treating the carbon support in a pH-14 bath at 80° C. for 1 hour, and iv) washing the carbon a second time with DI-H₂O followed by drying at 100° C. under vacuum.

Characterization of Pd Precursor Catalysts

Three precursor catalysts were examined by H₂ chemisorption to determine average Pd particle sizes and dispersions. The chemisorption data, summarized in Table XII, show that at 0.5% Pd loading, the bis-allyl palladium chloride precursor forms much larger Pd particle sizes than all other combinations of Pd precursor compound, Pd weight loading, or solvent selection. As a result, no higher Pd loaded catalysts were synthesized with this precursor. The relatively small average Pd particle diameters for 0.5% Pd loadings yielded by the other three precursor/solvent combinations encouraged further analysis with higher weight loadings of Pd. For the palladium acetate precursor, the data show that the Pd particle sizes remain approximately equal as the Pd weight loading increases from 0.5% to 5.0%, indicating that additional similarly-sized particles are being formed on the carbon surface instead of simply forming larger Pd particles. Thus, the number of Pd seed particles increases with Pd loading, which should result in the formation of more Pt particles during the electroless deposition of Pt. When the tetraamine palladium nitrate/water combination was used as the Pd source, increasing the Pd loading from 0.5% to 2.5% resulted primarily in larger Pd particles, indicating that Pd particle growth was favored over nucleation. This result is not surprising given the hydrophobic nature of carbon. The inability of water to wet the carbon surface results in “puddling” of Pd salts on the carbon surface, a phenomenon that leads to particle growth, not particle nucleation. When methanol, rather than water, is used as the solvent for tetraamine palladium nitrate, the results are much different. There are only small changes in average Pd particle diameters as the Pd weight loading increase from 0.5% to 2.5%, suggesting again that more Pd particles of the same diameter are being deposited instead of growth of larger Pd particles. This is also consistent with the observation that methanol wets carbon, giving a more even distribution of Pd precursor compounds over the entire carbon surface.

TEM Characterization

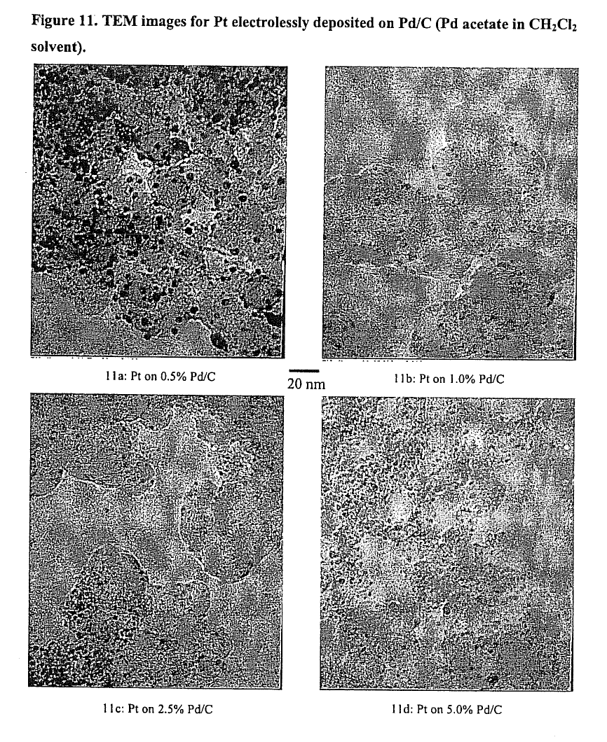

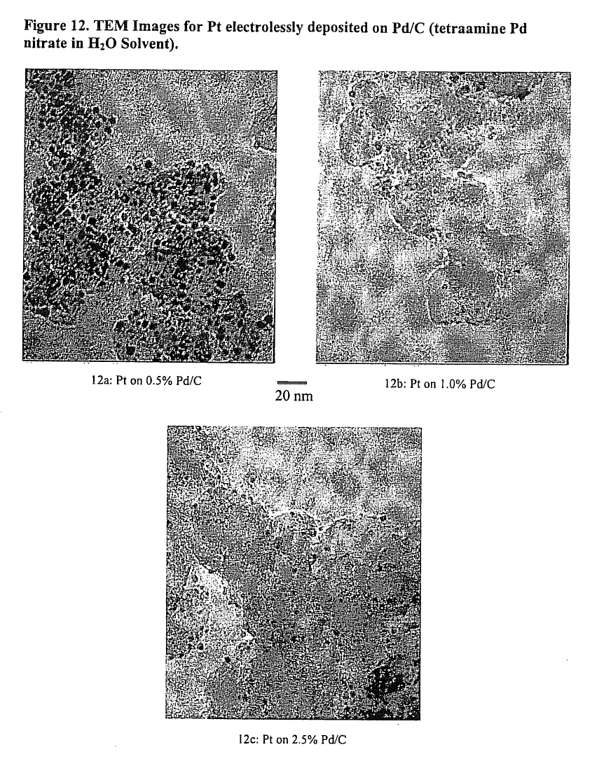

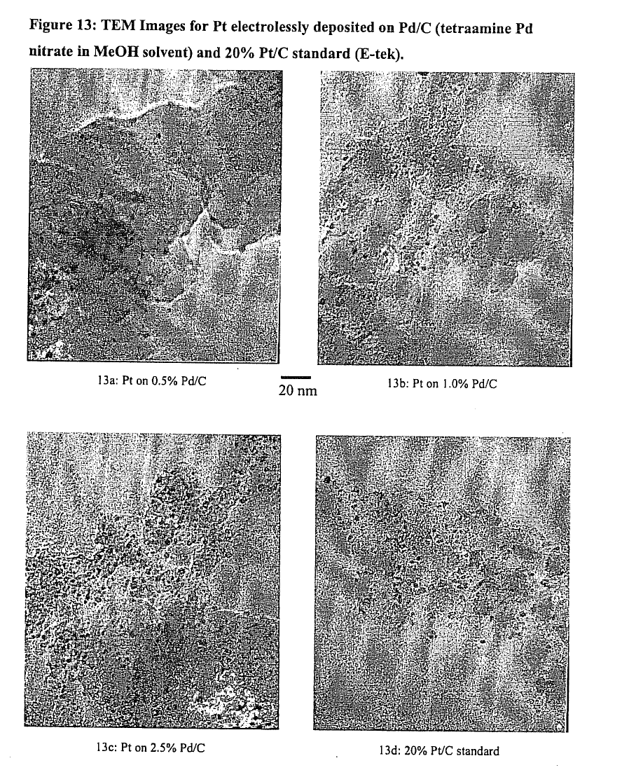

Transmission Electron Microscopy (TEM) was used to determine the average Pt particle sizes and Pt dispersions for Pt deposited by ED on the seeded Pd/C catalysts; these results are summarized in Table XIII and sample images shown in FIGS. 11-13. It was not possible to use TEM to characterize the Pd/C precursor catalysts synthesized by wet impregnation. The palladium particles were too small for the resolution of the TEM to capture images capable of being measured for the calculation of average particle diameter and dispersion; only the larger Pt particles were clearly resolvable by TEM. This represents an apparent contradiction between the chemisorption results of Table XII and the TEM results in Table XIII. The chemisorption results in Table XI show Pd particle sizes larger than the Pt particles deposited on the same Pd particles (Table XIII) as observed by TEM. This, of course, is physically impossible because the addition of the Pt shell to the Pd core can only increase the final particle size. The most likely explanation for this disparity is the different pretreatments given the samples before chemisorption and TEM analyses. While the catalyst tested by TEM and chemisorption are the same, the sample pretreatments are very different. Before chemisorption, samples are reduced at 200° C. in flowing H₂ for two hours and then evacuated for two hours at the same temperature before cooling to 35° C., where the chemisorption analysis is conducted. The high temperature treatment prior to chemisorption is essential to ensure reduction of the Pd particles and to attain the high vacuum conditions required for chemisorption. For TEM measurements, the samples are given no pretreatment before analyses are made. The pretreatment step for chemisorption very likely causes agglomeration of Pd particles. Therefore, it is most likely this pre-treatment step results in the formation of Pd particles which are larger than the actual size of the Pd particles formed during precursor synthesis. Regardless, the comparison data in Table XII are very useful in determining the proper combination of Pd precursor compound and solvent selection to be used for the subsequent ED experiments. For this reason, use of chemisorption was limited to examination of Pd precursor catalysts and not the Pt catalysts prepared by electroless deposition. Note that the highest temperature used during ED was 80° C.

For the Pd acetate and tetraamine Pd nitrate in MeOH precursor samples, the average Pt particle diameters decrease with increasing Pd loadings. This is because additional Pd particles are formed as the Pd loading increases, rather than the growth of pre-existing Pd particles (nucleation favored over growth). This results in the formation of more Pd seed sites for the electroless deposition of Pt (last column of Table XIII shows that more Pt particles are formed). For the deposition of similar loadings of Pt on more Pd nucleation sites, the Pt shells are thinner resulting in smaller Pt particles to give the observed decrease in Pt particle size with increasing Pd loading. However, this trend does not hold for the 5.0% Pd acetate precursor (Table XIII), suggesting that most of the effective nucleation sites on the carbon surface have been utilized at Pd loadings of 2.5%.

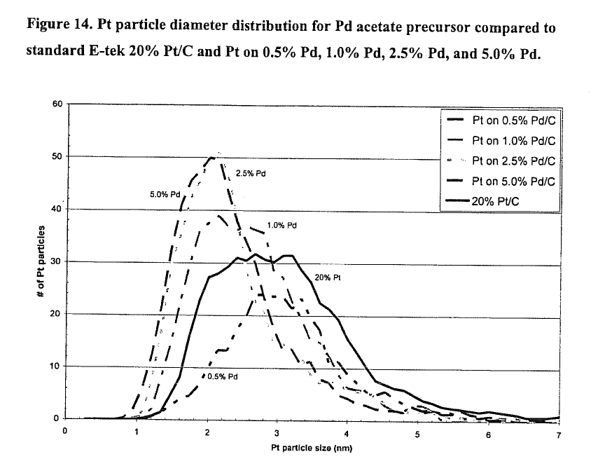

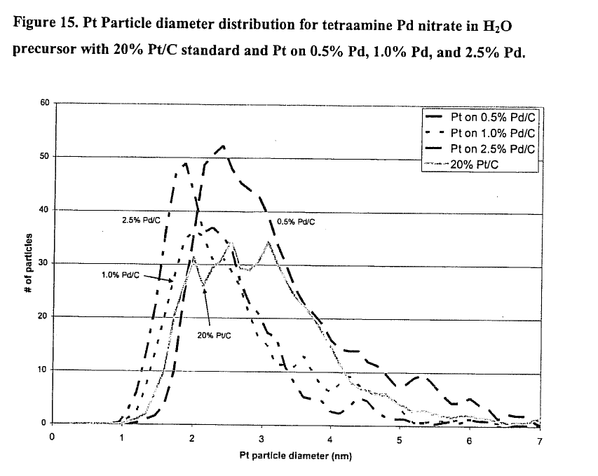

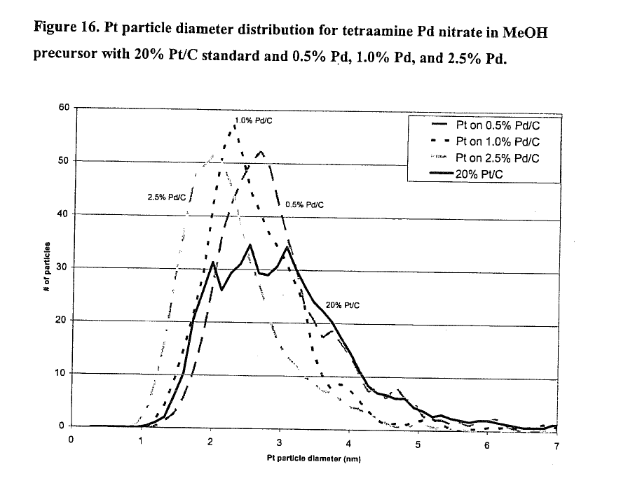

In addition to calculation of average Pt particle diameters and Pt dispersions, analysis of the TEM images permitted the determination of particle size distribution curves which are shown in FIGS. 14, 15, and 16 for the Pd acetate, tetraamine Pd nitrate/H2O, and the tetraamine Pd nitrate/MeOH precursor/solvent combinations, respectively.

For the distribution curves, the total number of Pt particles measured, for each sample was 500±50. Thus, good statistics were obtained for each sample. In all cases for the different Pd precursors, the Pt particle size distribution curves shift to smaller particle diameters, also seen in Table XIII. More importantly, the size distribution curves in FIGS. 14-16 indicate the Pt particle size distributions are narrower for the samples prepared by electroless deposition when compared to the standard 20% Pt/C sample from E-tek. This narrower particle size distribution also benefits Pt dispersion because the volume of a particle increases with the cube of the diameter. Therefore, larger particles consume inordinately large amounts of platinum that are contained within the bulk of large Pt particles, and are thus unavailable for electrocatalysis. Clearly, one of the benefits of ED is the ability to control the architecture of the Pt particles.

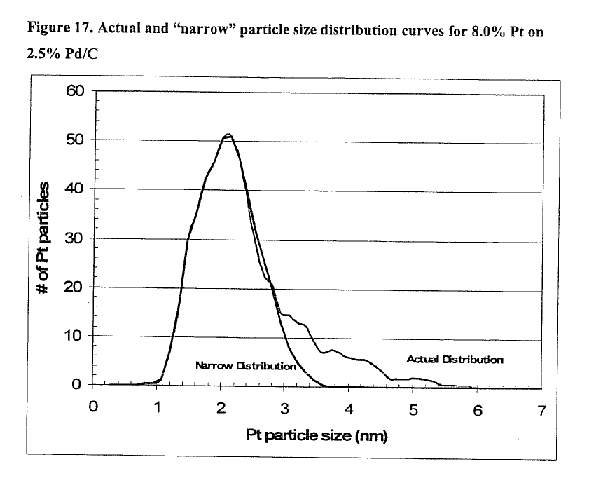

To better understand the effect of the particle size distribution on Pt surface site concentrations, an artificial, narrow distribution curve has been generated based on the actual particle size distribution for the sample prepared from the 2.5% Pd (Pd acetate precursor) shown in FIG. 14. This curve, shown in FIG. 17 along with the actual size distribution, was made by forming a nearly symmetrical distribution curve using the left hand side of the actual distribution. The large particle “tail portion” of the actual curve was removed and the extra Pt was redistributed back into the new particle distribution curve. The results of removing the large particle tail are quite dramatic, as shown in Table XIV. By removing the tail portion of the distribution curve, the concentration of Pt particles is almost doubled and the number of Pt sites per gram of catalyst increases by 35%, while the average Pt particle diameter decreases from 3.0 nm to 2.2 nm. It is obvious that much benefit can be gained from further control of Pt particle size distributions. Preparation of Pt catalysts using improved electroless deposition methods appears to afford possibilities in this area.

Electrochemical Characterization

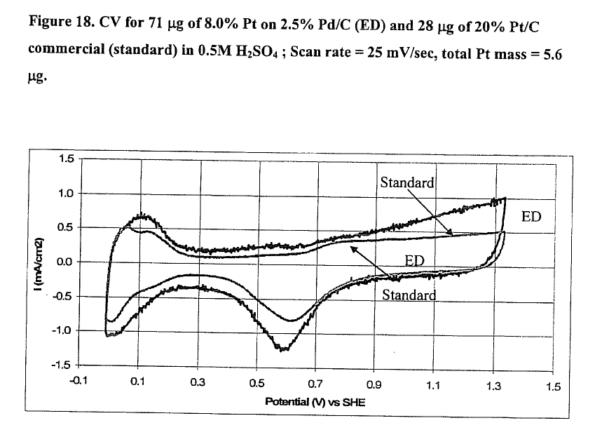

The ED synthesized catalysts were characterized electrochemically and compared to the commercial standard catalyst using a Rotating Ring-Disk Electrode (RRDE) to determine: i) the active electrochemical surface area, and ii) the activity towards oxygen reduction. For the former, Cyclic Voltammetry (CV) was performed in a deaerated electrolyte solution while the latter was tested in an O₂ saturated electrolyte solution. To determine the electrochemically active surface area, the area under the hydrogen desorption peaks was measured and converted to surface area using the constant 210 μC/cm₂. The hydrogen adsorption peak was less reproducible and had an unusually high apparent surface area which might indicate the occurrence of a Faradaic reaction. FIG. 18 shows cyclic voltammograms of the 8.0% Pt on 2.5% Pd/C ED catalyst and the 20% Pt/C E-tek standard catalyst in perchloric acid electrolyte solution.

The commercial E-tek catalyst demonstrated dual hydrogen desorption peaks around ˜0.1 V, indicative of H₂ desorption from two different Pt surface orientations while the ED catalyst only had a single desorption peak suggesting a more uniform surface Pt orientation. Further, the results show the ED catalyst possesses approximately 35% more surface area per gram of Pt, corroborating the TEM results that showed the Pt particles were smaller for the ED catalysts than the E-tek catalyst.

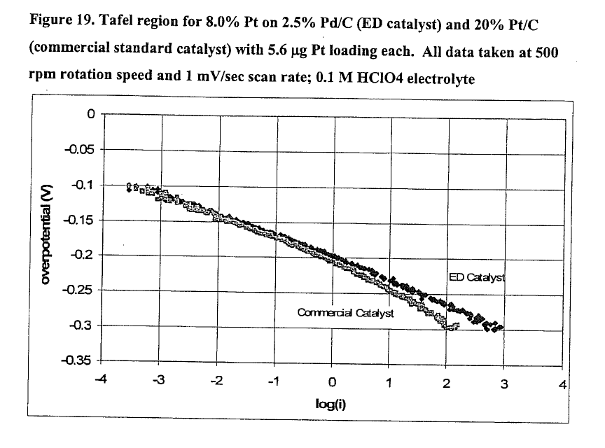

To evaluate the activity of the two catalysts towards ORR, the HClO₄ electrolyte was aerated and polarization curves were measured at different rotation rates. Tafel regions in the polarization curves were identified and analyzed, to determine the Tafel slope, the exchange current density, and the cathodic transfer coefficient. The Tafel regions for the two catalysts are shown in FIG. 19 while Table XVI shows the kinetic constants determined by analysis of the Tafel region. The ED catalyst, 8.0% Pt on 2.5% Pd/C, demonstrated a single Tafel slope throughout the Tafel region; conversely, the standard 20% Pt/C E-tek catalyst diverged from the ED catalyst at about −0.2 V of overpotential, but does not clearly form a second slope instead taking on a curvature which remains throughout the Tafel region further indicating the more uniform structure of catalysts prepared by electroless deposition.

O_{2,ads}+e⁻→O_{2,ads}⁻ (xx)

O₂+Pt →O_{2,ads} (xx)

From Table XVI, it is clear that the two catalysts very closely mirror one another in terms of ORR performance because all three key parameters, Tafel slope, exchange current density, and cathodic transfer coefficient (α_{c}) are very similar in both electrolytes. However, the results in Table XV indicate that the ED-derived catalysts have approximately 33% more surface Pt sites per gram of Pt used in catalyst synthesis.

Conclusion

The technique for synthesizing carbon-supported Pt catalysts by electroless deposition has been modified to produce greater Pt dispersions and a smaller Pt particle sizes. This increase in Pt dispersion was accomplished by better distributing the precursor catalyst over the carbon support which results from two changes to the synthesis procedure. First, the carbon surface was functionalized by deprotonating the carboxylic surface groups

TABLE I
Effect of pH on PtCl₆²⁻ adsorption
Effect of pH on PtCl₆²⁻ adsorption
Conditions of Experiment

1) carbon blank support (0.0 Rh wt %)
2) 80 C.
3) 1 hr depostion time
4) Pt:DMAB:Citrate = 1:0:4
5) variable pH
6) Theoretical Max Pt Depostion Loading = 6.7%

| pH | wt % Pt | |
|---|---|---|
| 4.0 | 6.0 | |
| 4.0 | 4.8 | (support pretreated in pH = 14 before ED bath) |
| 12.5 | 0.2 | |

TABLE II
Decomposition of Pt on blank carbon support
Electroless Depostion/Decomposition of Pt on blank carbon
Conditions of Experiment

1) carbon blank support (0.0 Rh wt %)
2) 80 C.
3) 1 hr deposition time
4) Pt:DMAB:Citrate = 1:5:5
5) variable pH
6) Theoretical Max Pt Depostion Loading = 6.7%

| pH | wt % Pt |
|---|---|
| 8.0 | 4.6 |
| 11.5 | 0.6 |
| 12.7 | 0.3 |

TABLE III
Effect of DMAB Concentrations on Pt Weight Loading
Effect of DMAB Concentrations in Electroless Deposition
Conditions of Experiment

1) 0.5% Rh/XC-72
2) 80 C.
3) 1 hr deposition time
4) Variable Pt:DMAB:Citrate ratios
5) pH = 11
6) Theoretical Max Pt Deposition Loading = 6.7%

| Pt:DMAB:Citrate | pH | wt % Pt |
|---|---|---|
| 1:0:5 | 12.5 | 0.2 |
| 1:1:5 | 11 | 1 |
| 1:2:5 | 11 | 3.5 |
| 1:4:5 | 11 | 3.7 |
| 1:5:5 | 11 | 5.5 |
| 1:6:5 | 11 | 6.4 |

TABLE IV
Effect of Citrate Concentration on Electroless Deposition
Effect of Citrate on Electroless Deposition/Decomp. of Pt
Conditions of Experiment

1) 0.5% Rh/XC-72
2) 80 C.
3) 1 hr deposition time
4) Variable Pt:DMAB:Citrate ratios
5) pH = 11
6) Theoretical Max Pt Deposition Loading = 6.7%

| Pt:DMAB:Citrate | wt % Pt |
|---|---|
| 1:5:2 | 2.8 |
| 1:5:5 | 5.5 |
| 1:5:8 | 3.3 |

TABLE V
Effect of Rh Weight Loading on Pt Weight Loading
Effect of Rh Loading on Electroless Deposition of Pt on Rh
Conditions of Experiment

1) variable Rh wt % supports
2) 80 C.
3) 1 hr deposition time
4) Pt:DMAB:Citrate = 1:5:5
5) pH = 11 and 13
6) Theoretical Max Pt Deposition Loading = 6.7%

| Rh Wt % | Pt:DMAB:Citrate | pH | wt % Pt |
|---|---|---|---|
| 0 | 1:5:5 | 11.5 | 0.6 |
| 0.1 | 1:5:5 | 11 | 2.9 |
| 0.5 | 1:5:5 | 11 | 5.5 |
| 2.5 | 1:5:5 | 11 | 6.7 |
| 5 | 1:5:5 | 11 | 6.7 |
| 0 | 1:5:5 | 12.5 | 0.3 |
| 0.1 | 1:5:5 | 13 | 0.7 |
| 0.5 | 1:5:5 | 13 | 1.1 |
| 2.5 | 1:5:5 | 13 | 4.6 |
| 5 | 1:5:5 | 13 | 5.4 |

TABLE VI
Effect of pH on Electroless Deposition
Effect of pH on electroless deposition of Pt on Rh
Conditions of Experiment

1) 0.5% Rh/XC-72
2) 80 C.
3) 1 hr deposition time
4) Pt:DMAB:Citrate = 1:5:5
5) variable pH
6) Theoretical Max Pt Deposition Loading = 6.7%

| pH | wt % Pt |
|---|---|
| 9 | 5.3 |
| 10 | 6 |
| 11 | 6.5 |
| 12 | 2.5 |
| 13 | 1.6 |

TABLE VII
Rate Constants

| | Initial Rate |
|---|---|
| Conditions of Experiment | Constant |
| Pt:DMAB:Citrate = 1:5:5, pH = 11, Rh loading = 0.1% | 0.10 |
| Pt:DMAB:Citrate = 1:5:5, pH = 11, Rh loading = 0.5% | 0.31 |
| Pt:DMAB:Citrate = 1:5:5, pH = 11, Rh loading = 5.0% | 0.34 |
| Pt:DMAB:Citrate = 1:5:5, pH = 9, Rh loading = 0.5% | 0.28 |
| Pt:DMAB:Citrate = 1:5:5, pH = 11, Rh loading = 0.5% | 0.31 |
| Pt:DMAB:Citrate = 1:5:5, pH = 13, Rh loading = 0.5% | 0.05 |
| Pt:DMAB:Citrate = 1:2:5, pH = 11, Rh loading = 0.5% | 0.05 |
| Pt:DMAB:Citrate = 1:4:5, pH = 11, Rh loading = 0.5% | 0.06 |
| Pt:DMAB:Citrate = 1:5:5, pH = 11, Rh loading = 0.5% | 0.31 |
| Pt:DMAB:Citrate = 1:5:2, pH = 11, Rh loading = 0.5% | 0.15 |
| Pt:DMAB:Citrate = 1:5:5, pH = 11, Rh loading = 0.5% | 0.15 |
| Pt:DMAB:Citrate = 1:5:8, pH = 11, Rh loading = 0.5% | 0.18 |

TABLE VIII
Propylene Hydrogenation Data

| | reaction rate | active sites | total Rh atoms | Dispersion |
|---|---|---|---|---|
| catalyst | μmol/min*g_{cat} | sites/g_{cat} | atoms/g_{cat} | surface/total |
| 2% Rh on | 5.61E+04 | 4E+19 | 1.2E+20 | 0.36 |
| Silica | | | | |
| 0.5% Rh | 2.44E+04 | 2E+19 | 2.9E+19 | 0.63 |
| on XC-72 | | | | |
| 2.5% Rh | 1.09E+05 | 8E+19 | 1.5E+20 | 0.56 |
| on XC-72 | | | | |
| 5.0% Rh | 1.69E+05 | 1E+20 | 2.5E+20 | 0.52 |
| on XC-72 | | | | |

TABLE IX
Results from TEM Analysis

| | | | TEM Analysis | | | |
|---|---|---|---|---|---|---|
| | | | | | Dispersion | Conc Pt |
| | Conc. Rh seed | Pt. Wt. Loading | Particles | Avg Particle Dia. | surface/total | Particles |
| RhDCC-72 Seed | particles/g_{cat} | % | Counted | Å | atoms | particles/g_{cat} |
| 0.4% Rh on XC-72 | 2.3E+17 | 5.5 | 177 | 69 | 0.16 | 1.7E+16 |
| 2.2% Rh on XC-72 | 6.9E+17 | 6.8 | 229 | 51 | 0.22 | 5.4E+16 |
| 4.3% Rh on XC-72 | 7.1E+17 | 6.8 | 255 | 28 | 0.4 | 3.2E+17 |

TABLE X
Results from TEM Analysis

| | Conc. Rh | | | Conc Pt |
|---|---|---|---|---|
| | seed | | | Particles |
| | particles/ | Pt Wt | Particles | particles/ |
| Rh/XC-72 Seed | g_{cat} | Loading % | Counted | g_{cat} |
| 0.4% Rh on XC-72 | 2.3E+17 | 5.5 | 177 | 1.7E+16 |
| 2.2% Rh on XC-72 | 6.9E+17 | 6.8 | 229 | 5.4E+16 |
| 4.3% Rh on XC-72 | 7.1E+17 | 6.8 | 255 | 3.2E+17 |

TABLE XI
Evaluation of Carbon Support Pretreatments

| Pd | | | Avg. Pd | Pd |
|---|---|---|---|---|
| Loading | | | Particle | Dispersion |
| % | Precursor | Pretreatment | Diameter Å | % |
| 0.5 | bis-allyl Pd | none | 72 | 15.5 |
| 0.5 | bis-allyl Pd | pH-14 bath | 57 | 19.7 |
| 0.5 | Pd-acetate | none | 117 | 9.5 |
| 0.5 | Pd-acetate | pH-14 bath | 33 | 34.5 |

TABLE XII
Results of H₂ chemisorption analysis for Pd precursor catalysts

| Pd | | | Avg. Pd | Pd |
|---|---|---|---|---|
| Loading | | | Particle | Dispersion |
| % | Precursor | Solvent | Diameter Å | % |
| 0.5 | bis-allyl Pd | CH₂Cl₂ | 57 | 19.7 |
| 0.5 | Pd-acetate | CH₂Cl₂ | 33 | 34.5 |
| 1.0 | Pd-acetate | CH₂Cl₂ | 41 | 27.6 |
| 2.5 | Pd-acetate | CH₂Cl₂ | 38 | 29.8 |
| 5.0 | Pd-acetate | CH₂Cl₂ | 40 | 28.3 |
| 0.5 | tetraamine-Pd | H₂O | 33 | 34.5 |
| 1.0 | tetraamine-Pd | H₂O | 66 | 17.2 |
| 2.5 | tetraamine-Pd | H₂O | 85 | 13.3 |
| 0.5 | tetraamine-Pd | MeOH | 40 | 28.3 |
| 1.0 | tetraamine-Pd | MeOH | 33 | 34.5 |
| 2.5 | tetraamine-Pd | MeOH | 40 | 28.3 |

TABLE XIII
Results from TEM Analysis

| | | | TEM Results | | |
|---|---|---|---|---|---|
| | | | Avg. Pt | | Concentration of |
| | Pd Loading | Pt loading | Particle Diameter | Concentration of | Pt particles |
| Precursor | % | % | Å | surface Pt sites/gcat | particles/gcat |
| n/a | n/a | 19.2 | 40 | 1.7E+20 | 4.4E+17 |
| Pd-acetate | 0.5 | 7.0 | 38 | 7.0E+19 | 1.8E+17 |
| Pd-acetate | 1.0 | 8.4 | 32 | 9.2E+19 | 3.3E+17 |
| Pd-acetate | 2.5 | 8.4 | 30 | 9.8E+19 | 4.2E+17 |
| Pd-acetate | 5.0 | 8.4 | 32 | 9.3E+19 | 4.1E+17 |
| tetraamine - H₂O | 0.5 | 7.6 | 40 | 6.7E+19 | 1.6E+17 |
| tetraamine - H₂O | 1.0 | 8 | 34 | 8.3E+19 | 2.8E+17 |
| tetraamine - H₂O | 2.5 | 8.5 | 34 | 8.7E+19 | 3.5E+17 |
| tetraamine - MeOH | 0.5 | 7.6 | 35 | 7.5E+19 | 2.1E+17 |
| tetraamine - MeOH | 1.0 | 8.2 | 34 | 8.4E+19 | 2.9E+17 |
| tetraamine - MeOH | 2.5 | 8.1 | 28 | 1.0E+20 | 4.9E+17 |

TABLE XIV
Comparison of actual and narrow particle size
distribution for 8.0% Pt on 2.5% Pd/C

| | Avg. | Pt | Surface | |
|---|---|---|---|---|
| | diameter Pt | Dispersion | Pt sites/ | Particles/gm |
| | particles (nm) | (%) | gm catalyst | catalyst |
| Actual | 3.0 | 38 | 9.8 × 10¹⁹ | 4.24 × 10¹⁷ |
| Distribution | | | | |
| Narrow | 2.2 | 52 | 1.35 × 10²⁰ | 8.3 × 10¹⁷ |
| Distribution | | | | |

TABLE XV
Results from hydrogen desorption peak analysis

| | Pt Loading | Pd Loading | Catalyst Mass | Pt Mass | Desorption Area |
|---|---|---|---|---|---|
| Electrolyte | % | % | μg | μg | avg cm² |
| Perchloric | 20 (E-tek) | n/a | 28 | 5.6 | 4.5 ± 0.3 |
| Perchloric | 8.0 | 2.5 | 70 | 5.6 | 6.0 ± 0.1 |

TABLE XVI
Kinetic parameters from Tafel Region for ORR

| | Pt Loading | Pd Loading | Catalyst Mass | Pt Loading | Tafel Slope | exchange current | α_{c} |
|---|---|---|---|---|---|---|---|
| Electrolyte | % | % | μg | μg | mV/decade | density A/cm² | 1/V |
| Perchloric | 20 (E-tek 1 | n/a | 28 | 5.6 | −67.2 ± 1.5 | 1.5 ± 0.6 ^{±}10⁻⁶ | 0.22 |
| Perchloric | 8.0 | 2.5 | 70 | 5.6 | −70.7 ± 3.8 | 1.5 ± 0.6 ^{±}10⁻⁶ | 0.21 |

1. A process for electroless deposition of metal atoms on an electrode comprising:
treating a carbon-containing support by contacting said carbon-containing support with a treatment;
impregnating said carbon-containing support with a precursor metal component to form seed sites on said carbon-containing support; and
depositing metal atoms on said seed sites through electroless deposition by contacting said carbon-containing support with a metal salt and a reducing agent.

2. The process of claim 1, wherein said metal atoms comprise Pt.

3. The process of claim 1, wherein said metal atoms comprise a Group VIII or Group IB element.

4. The process of claim 1, wherein said metal salt comprises chloroplatinic salt.

5. The process of claim 1, wherein said metal salt comprises a Group VIII or Group IB metal salt.

6. The process of claim 1, wherein said reducing agent comprises sodium hypophosphite, hydrazine, dimethylamine borane, alkylamine borane, sodium borohydride, or formaldehyde.

7. The process of claim 1, wherein said precursor metal component comprises Rh.

8. The process of claim 1, wherein said precursor metal component comprises Pd.

9. The process of claim 1, wherein said precursor metal component comprises a Group VIII or Group IB element.

10. The process of claim 1, wherein said precursor metal component comprises a metal salt.

11. The process of claim 1, wherein said carbon-containing support comprises carbon black, activated carbon, or carbon nanotubes.

12. The process of claim 1, wherein said treatment comprises an alkaline treatment.

13. The process of claim 1, wherein said treatment bath comprises an acidic treatment.

14. A process for electroless deposition of metal atoms on an electrode comprising:
treating a carbon-containing support by contacting said carbon-containing support with an oxidizing treatment;
impregnating said carbon-containing support with a precursor metal component to form seed sites on said carbon-containing support;
depositing metal atoms on said seed sites through electroless deposition by contacting said carbon-containing support seed sites with a metal salt and a reducing agent; and
depositing additional metal atoms at said seed sites by contacting said metal atoms with a metal salt and a reducing agent.

15. The process of claim 14, wherein a solvent is present when impregnating said carbon-containing support with a precursor metal component to form seed sites on said carbon-containing support.

16. The process of claim 15, wherein said solvent comprises dichloromethane, toluene, methanol, or deionized water.

17. The process of claim 14, wherein a stabilizing agent is present in when contacting said carbon-containing support seed sites with a metal salt and a reducing agent.

18. The process of claim 17, wherein said stabilizing agent comprises sodium citrate.

19. The process of claim 14, wherein said metal atoms and said additional metal atoms comprise different elements.

20. The process of claim 14, wherein said metal atoms comprise Pt.

21. The process of claim 14, wherein said metal salt comprises a Group VIII or Group IB metal salt.

22. The process of claim 14, wherein said precursor metal component comprises Pd.

23. The process of claim 14, wherein said precursor metal component comprises a Group VIII or Group IB element.

24. The process of claim 14, wherein said oxidizing treatment comprises an alkaline treatment.

25. The process of claim 14, wherein said oxidizing treatment comprises an acidic treatment.
